(19) United States
(12) Patent Application Publication
(10) Pub. No.: US 2021/0293267 A1
(43) Pub. Date: Sep. 23, 2021

(54) THREADED FASTENER

(71) Applicant: Engineered Components Company, Elgin, IL (US)

(72) Inventor: Arne Henriksen, JR., Algonquin, IL (US)

(21) Appl. No.: 17/205,484

(22) Filed: Mar. 18, 2021

Related U.S. Application Data
(60) Provisional application No. 62/991,143, filed on Mar. 18, 2020.

(51) Int. Cl. F16B 33/02

(52) U.S. Cl. CPC F16B 33/02

(57) ABSTRACT

A fastener having a head and a shaft extending from a first end at the head to a second end forming a tip. The shaft has a first threaded portion and a second threaded portion. The first threaded portion is disposed at the tip. A hardness of the first portion is higher than a hardness of the second threaded portion.

### RELATED APPLICATIONS

This application claims priority to U.S. Provisional Patent Application Ser. No. 62/991,143 filed on Mar. 18, 2020, the entirety of which is incorporated herein by reference.

### FIELD AND BACKGROUND OF THE INVENTION

The present invention relates to a threaded fastener, and in particular to a fastener for use in the beds of vehicles. These threaded fasteners are installed and subjected to various forces in all directions.

While presumably effective for their intended purposes, some current fasteners break under various forces. As will be appreciated, it is undesirable to have the fasteners break. Accordingly, the present invention is directed at addressing one or more drawbacks associated with conventional fasteners.

### SUMMARY OF THE INVENTION

A new fastener has been invented. The present threaded fastener has an increased strength compared with conventional fasteners. The present threaded fastener resists breaking under forces that have a tendency to break conventional fasteners.

Generally, the present fasteners include a head and a shaft extending from a first end at the head to a second end forming a tip. The shaft has a first threaded portion and a second threaded portion. The first threaded portion is disposed at the tip. A hardness of the first portion is higher than a hardness of the second threaded portion.

Accordingly, in a first aspect the present invention may be broadly characterized as providing a fastener having a head and a shaft extending from a first end at the head to a second end the second end forming a tip of the shaft. The head includes a recessed portion configured to receive a suitable driving tool. The shaft has a first portion and a second portion, and both the first portion and the second portion are threaded. The first portion is disposed at the tip of the shaft and the second portion is disposed between the first portion and the head along a longitudinal axis of the fastener. A hardness of the first portion is higher than a hardness of the second portion.

The first portion may have an outer diameter which increases along the longitudinal axis of the fastener in a direction from the tip to the head. The second portion may have a constant outer diameter.

The fastener may be made from 4037 alloy steel.

The first portion may have a first thread count and the portion may have a second thread count. The second thread count may be the same as the first thread count.

The shaft may also include a third portion disposed between the second portion and the head. The third portion may have an outer surface that lacks threads. The hardness of the first portion may be higher than a hardness of the third portion.

The first portion and the second portion may be treated in a first hardening process, and only the first portion may be treated in a second hardening process. The first hardening process may be a heat treatment. The second hardening process may be a case hardening.

The fastener may be plated with, for example, zinc.

Accordingly, in a second aspect the present invention may be broadly characterized as providing a method of making a fastener. The fastener includes a head and a shaft extending from a first end at the head to a second end which forms a tip of the shaft. The shaft has a first portion and a second portion that are both threaded. The first portion is disposed at the tip of the shaft and the second portion is disposed between the first portion and the head along a longitudinal axis of the fastener. The method includes treating the fastener to provide a first hardness to the fastener and then, treating only the first portion of the fastener to obtain a second hardness higher than the first hardness. The second portion may have the first hardness.

The first hardness may be provided by a heat treatment. The second hardness may be provided by a case hardening. Both the first portion and the second portion may be treated with the heat treatment, and only the first portion may be treated with the case hardening. The method may further include plating zinc on the fastener after the case hardening.

These and other aspects and embodiments of the present invention will be appreciated by those of ordinary skill in the art based upon the following description of the drawings and detailed description of the preferred embodiments.

### BRIEF DESCRIPTION OF THE DRAWINGS

The invention, together with objects and advantages that will be appreciated, may best be understood by reference to the following description taken in conjunction with the accompanying drawings, in the several Figures in which like reference numerals identify like elements, and in which:

FIG. 1 is a side view of a threaded fastener according to one or more embodiments of the present invention.

FIG. 2 is front view of the fastener of FIG. 1.

### DETAILED DESCRIPTION OF THE PREFERRED EMBODIMENTS

As mentioned above, a new fastener has been invented which is stronger compared with conventional fasteners having a similar size.

With these general principles in mind, one or more embodiments of the present invention will be described with the understanding that the following description is not intended to be limiting.

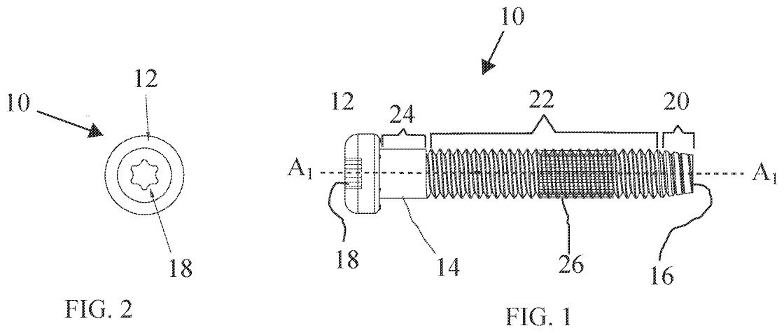

FIGS. 1 and 2 illustrate a threaded fastener 10 having a head 12 and a shaft 14 extending away from the head 12 and terminating in a tip 16. The shaft 14 extends along a longitudinal axis A₁-A₁ of the fastener 10.

The head 12 of the fastener 10 includes a recessed portion 18 that is sized and shaped to receive a tool for rotationally driving the threaded fastener 10. The recessed portion 18 as shown is adapted to receive a TORX®, or equivalent, driving tool, but it is contemplated that the recessed portion 18 can be adapted or shaped to receive any suitable driving tool, such as a Phillips screwdriver, a flathead screwdriver, an Allen wrench, or a socket wrench.

The shaft 14 includes a first portion 20 that is threaded and a second portion 22 that is also threaded. The first portion 20 is at the tip 16 of the shaft 14—opposite the head 12 of the fastener 10. The second portion 22 is disposed between the first portion 20 and the head 12 along the axis of the longitudinal axis A₁-A₁ of the fastener 10. A third portion 24 may be disposed along the axis of the longitudinal axis A₁-A₁ of the fastener 10 between the second portion 22 and the head 12. Unlike the first and second portions 20, 22, the third portion 24 is not threaded and may include a surface that is smooth, or textured.

The first portion 20 is configured to initially drive the fastener 10 into a material. The first portion 20 has an outer diameter which increases along the axis A₁-A₁ in a direction from the tip 16 to the head 12. The second portion 22 preferably has a generally constant outer diameter. The second portion 22 may be produced with a thread count of 18 threads/inch, and the first portion 20 may have a thread count that is greater, lesser, or equal to the thread count of the second portion 22.

The threads on the shaft 14 may be formed by a rolling process, like cold rolling or hot rolling. An adhesive 26 may also be included on the shaft 14 which functions to secure the fastener 10 in the material. Accordingly, the adhesive 26 may harden when the fastener 10 is installed.

The first portion 20 has a higher hardness (HRC) value compared with the second portion 22. As used herein, the “hardness” refers to the hardness according to the Hardness Rockwell C (“HRC”) scale and test. For example, the second portion 22 may have a hardness (core to outer surface) between 25 to 40, or between 33 to 39, while the first portion 20 may have an outer surface that has a hardness greater than 40, for example about 45 or 50.

Accordingly, the fastener 10 may be subjected to a first hardening process like a heat treatment to obtain a hardness value of the second portion 22. For example, the heat treatment may include annealing, tempering, and quenching. Then, just the tip 16 of the fastener 10, and specifically, just the first portion 20, may be subjected to a second hardening process, for example a case hardening process, so that the first portion 20 of the fastener 10 obtains an outer surface that has a higher hardness value than the other portions of the fastener 10 that were not subjected to the second hardening process like the second portion 22, the third portion 24, and the head 12. If the entire fastener 10 were subjected to the second hardening process, the fastener 10 would be too brittle and not pliable enough. Thus, it would likely break after bending only a few degrees.

The fastener 10 may be made from socket quality 4037 Alloy steel which is typically not used for such fasteners 10. The fastener 10 may also be plated, for example, with zinc, after the first and second hardening processes.

It is particularly preferred that the outer diameter of the second portion 22 is 11/32 of an inch, with 18 threads per inch. It has been found that such a sized fastener has a tip with a sufficient strength to drill in, but the shaft is sufficiently pliable to accommodate the forces that the fastener may be subjected to. By having some flexibility in the shaft, the fastener may bend (in some instances up to 30 degrees) without breaking. Thus, the present fastener may be used in applications in which the fasteners are subjected to large forces that often break conventional fasteners.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

Claimed is:

1. A fastener comprising:
a head, the heading including a recessed portion configured to receive a suitable driving tool; and,
a shaft extending from a first end at the head to a second end, the second end forming a tip of the shaft,
wherein the shaft has a first portion and a second portion, both the first portion and the second portion being threaded, the first portion disposed at the tip of the shaft and the second portion between the first portion and the head along a longitudinal axis of the fastener, and,
wherein a hardness of the first portion is higher than a hardness of the second portion.

2. The fastener according to claim 1, wherein the first portion has an outer diameter which increases along the longitudinal axis of the fastener in a direction from the tip to the head.

3. The fastener according to claim 2, wherein the second portion has a constant outer diameter.

4. The fastener according to claim 1, wherein the fastener is made from 4037 alloy steel.

5. The fastener according to claim 1, wherein the first portion has a first thread count and the second portion has a second thread count, and
wherein the second thread count is the same as the first thread count.

6. The fastener according to claim 1, wherein the shaft further comprises a third portion disposed between the second portion and the head.

7. The fastener according to claim 6, wherein the third portion comprises an outer surface that lacks threads.

8. The fastener according to claim 7, wherein the hardness of the first portion is higher than a hardness of the third portion.

9. The fastener according to claim 1, wherein the first portion and the second portion are treated in a first hardening process, and
wherein only the first portion is treated in a second hardening process.

10. The fastener according to claim 9, wherein the first hardening process comprises a heat treatment.

11. The fastener according to claim 10, wherein the second hardening process comprises a case hardening.

12. The fastener according to claim 9, wherein the second hardening process comprises a case hardening.

13. The fastener according to claim 1, wherein the fastener is plated.

14. The fastener according to claim 13, wherein the fastener is plated with zinc.

15. A method of making a fastener having a head and a shaft extending from a first end at the head to a second end, the second end forming a tip of the shaft, wherein the shaft has a first portion and a second portion, the first portion and the second portion being threaded, the first portion disposed at the tip of the shaft and the second portion between the first portion and the head along a longitudinal axis of the fastener, and wherein the method comprises:
treating the fastener to provide a first hardness to the fastener; and,
then, treating only the first portion of the fastener to obtain a second hardness higher than the first hardness,
wherein the second portion comprises the first hardness.

16. The method of claim 15, wherein the first hardness is provided by a heat treatment.

17. The method of claim 16, wherein the second hardness is provided by a case hardening.

18. The method of claim 17, wherein both the first portion and the second portion are treated with the heat treatment, and
wherein only the first portion is treated with the case hardening.

19. The method of claim 15, wherein the second hardness is provided by a case hardening.

20. The method of claim 19, further comprising:
plating zinc on the fastener after the case hardening.
